(19) United States
(12) Patent Application Publication
(10) Pub. No.: US 2021/0303000 A1
(43) Pub. Date: Sep. 30, 2021

(54) INFORMATION PROCESSING DEVICE, INFORMATION PROCESSING METHOD, AND INFORMATION PROCESSING SYSTEM

(71) Applicant: TOYOTA JIDOSHA KABUSHIKI KAISHA, Toyota-shi (JP)

(72) Inventors: Toshinari OGAWA, Nagoya-shi (JP); Kohta TARAO, Nagoya-shi (JP); Shinya KIJIMA, Nagoya-shi (JP); Osamu FUKAWATASE, Miyoshi-shi (JP); Koji YASUI, Toyota-shi (JP); Toshiyuki KOBAYASHI, Miyoshi-shi (JP); Hitomi NAKATANI, Toyota-shi (JP); Kuniaki JINNAI, Nagoya-shi (JP); Nobuki HAYASHI, Nisshin-shi (JP); Masahiro NAGANO, Toyota-shi (JP); Akihiro ITO, Shinagawa-ku (JP)

(73) Assignee: TOYOTA JIDOSHA KABUSHIKI KAISHA, Toyota-shi (JP)

(21) Appl. No.: 17/203,933

(22) Filed: Mar. 17, 2021

(30) Foreign Application Priority Data
Mar. 27, 2020 (JP) 2020-057763

(51) Int. Cl. G05D 1/02; G05D 1/00

(52) U.S. Cl. CPC G05D 1/0291; G05D 1/0212; G05D 1/0061; G05D 1/0088; G05D 2201/0213; G05D 1/0285

(57) ABSTRACT

An information processing device according to the present disclosure includes a control unit configured to execute accepting a movement request for moving a target body unit from a prescribed place to a prescribed movement destination, acquiring specification information regarding the target body unit, selecting, out of chassis units in a free state, the chassis unit adapted to the specification information as a mobile chassis unit, and transmitting to the mobile chassis unit a movement command for moving the target body unit from the prescribed place to the prescribed movement destination.

### INCORPORATION BY REFERENCE

The disclosure of Japanese Patent Application No. 2020-057763 filed on Mar. 27, 2020 including the specification, drawings and abstract is incorporated herein by reference in its entirety.

### BACKGROUND

### 1. Technical Field

The present disclosure relates to a technique for managing a separable vehicle.

### 2. Description of Related Art

There have conventionally been proposed separable vehicles including a chassis unit capable of traveling on road and a body unit including a vehicle cabin or the like, the chassis unit and the body unit being formed to be freely separated from and joined to each other (for example, see WO 2018/230720).

### SUMMARY

An object of the present disclosure is to provide a technique that can enhance the utilization efficiency of chassis units.

The present disclosure can be comprehended as an information processing device for managing operation of chassis units, the chassis units being formed to be freely joined to and separated from body units and be autonomously travelable by autonomous driving.

The information processing device in this case may include a control unit configured to execute, for example, accepting a movement request that is a request for moving a target body unit that is the body unit stationarily disposed in a prescribed place from the prescribed place to a prescribed movement destination, acquiring specification information that is information regarding specification of the target body unit, selecting, out of the chassis units in a state of being separated from the body units, the chassis unit adapted to the specification information as a mobile chassis unit that is the chassis unit for moving the target body unit, and transmitting to the mobile chassis unit a movement command that is a command for moving the target body unit from the prescribed place to the prescribed movement destination.

The present disclosure can be comprehended as an information processing method for managing operation of chassis units, the chassis units being formed to be freely joined to and separated from body units and be autonomously travelable by autonomous driving.

For example, the information processing method in this case may be executed by a computer, the method including: a step of accepting a movement request that is a request for moving a target body unit that is the body unit stationarily disposed in a prescribed place from the prescribed place to a prescribed movement destination; a step of acquiring specification information that is information regarding specification of the target body unit; a step of selecting, out of the chassis units in a state of being separated from the body units, the chassis unit adapted to the specification information as a mobile chassis unit that is the chassis unit for moving the target body unit; and a step of transmitting to the mobile chassis unit a movement command that is a command for moving the target body unit from the prescribed place to the prescribed movement destination.

The present disclosure can be comprehended as an information processing system including chassis units formed to be freely joined to and separated from body units and be autonomously travelable by autonomous driving, and an information processing device for managing operation of the chassis units.

In the information processing system in this case, the information processing device may be configured to execute, for example, accepting a movement request that is a request for moving a target body unit that is the body unit stationarily disposed in a prescribed place from the prescribed place to a prescribed movement destination, acquiring specification information that is information regarding specification of the target body unit, selecting, out of the chassis units in a state of being separated from the body units, the chassis unit adapted to the specification information as a mobile chassis unit that is the chassis unit for moving the target body unit, and transmitting to the mobile chassis unit a movement command that is a command for moving the target body unit from the prescribed place to the prescribed movement destination, and the mobile chassis unit may be configured to execute receiving the movement command from the information processing device, generating an operation plan of the mobile chassis unit based on the movement command, and operating the mobile chassis unit in accordance with the operation plan.

The present disclosure can also be comprehended as an information processing program for causing a computer to execute the information processing method, or a non-transitory storage medium storing the information processing program in the form executable by a computer.

The present disclosure can provide a technique that can enhance the utilization efficiency of the chassis units.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view showing a sharing management system;

FIG. 2 is a first view showing schematic configuration of a separable vehicle;

FIG. 3 is a second view showing the schematic configuration of the separable vehicle;

FIG. 4 shows hardware configuration of a chassis unit and a server device;

FIG. 5 is a block diagram showing a functional configuration example of the chassis unit;

FIG. 6 is a block diagram showing a functional configuration example of the server device;

FIG. 7 shows a configuration example of a body unit information table in a first embodiment;

FIG. 8 shows a configuration example of a chassis unit information table in the first embodiment;

FIG. 9 is a flowchart showing the flow of a process executed by the server device in the first embodiment;

FIG. 10 shows a configuration example of the body unit information table in a first modification of the first embodiment;

FIG. 11 shows a configuration example of the chassis unit information table in the first modification of the first embodiment;

FIG. 12 shows a configuration example of the body unit information table in a second modification of the first embodiment;

FIG. 13 shows a configuration example of the chassis unit information table in the second modification of the first embodiment;

FIG. 14 shows a configuration example of the chassis unit information table in a third modification of the first embodiment;

FIG. 15 is a schematic view of a movement process in a second embodiment;

FIG. 16 is a flowchart showing the flow of a process executed by the server device in the second embodiment; and

FIG. 17 is a flowchart showing the flow of a process executed by the server device in a third embodiment.

### DETAILED DESCRIPTION OF EMBODIMENTS

The present disclosure allows a chassis unit in a separable vehicle to be shared, the separable vehicle including a body unit and the chassis unit formed to be freely separated from and joined to each other. The term “body unit” herein refers to a unit including, for example, space (staying space, such as residential space, kitchen space, shower space, or bathing space) used by a user when the user stays in a prescribed place. The term “chassis unit” refers to a unit formed to be freely separated from and joined to the body unit and be travelable on road.

The body unit of the separable vehicle may stationarily be disposed in a certain place over a relatively long period of time. Particularly, the body unit including the staying space has a high possibility of being stationarily disposed in a prescribed place over a relatively long period of time and a low possibility of being frequently moved. In such a use configuration, when the body unit is stationarily disposed in a prescribed place in the state of being joined to the chassis unit, an operation rate of the chassis unit may decrease. When the users of body units individually own chassis units that are rarely used, the users' economic burden may increase. Accordingly, the utilization efficiency of the chassis units may decrease.

As a solution, in the present disclosure, when a movement request is generated for a body unit stationarily disposed in a prescribed place, the body unit is moved by using a chassis unit that is in the state of being separated from any body unit. The term “state of being separated from any body unit” herein refers to the state where the pertinent chassis unit is not joined to any body unit (hereinafter also referred to as “free state”).

Specifically, in the information processing device of the present disclosure, a control unit first accepts a movement request for a body unit (target body unit) stationarily disposed in a prescribed place. For example, the movement request is transmitted from a terminal, or the like, used by a user of the body unit to the information processing device. When accepting such a movement request, the control unit selects, out of the chassis units under management of the information processing device, the chassis unit (mobile chassis unit) for moving the target body unit. At the time, the control unit selects, out of the chassis units under management of the information processing device, the chassis unit in a free state as the mobile chassis unit. The control unit transmits a movement command to the selected mobile chassis unit. The movement command is a command for moving the target body unit from the prescribed place to a prescribed movement destination. The mobile chassis unit which has received the movement command is joined to the target body unit in the prescribed place, and is moved to the prescribed movement destination from the prescribed place. Then, the control unit separates the mobile chassis unit from the target body unit at the prescribed movement destination. As a result, the target body unit is transported from the prescribed place to the prescribed movement destination by the mobile chassis unit. Thus, when a body unit needs to be moved, the body unit can be moved using a chassis unit in the free state. As a result, it becomes possible to share the chassis unit among a plurality of body units. Therefore, in the case where the target body unit is stationarily disposed in a prescribed place over a relatively long period of time or the like, it becomes unnecessary to stationarily dispose the target body unit in the state of being joined to a chassis unit. It also becomes unnecessary for the users of the target body units to individually own the chassis units. Therefore, the utilization efficiency of the chassis units can be enhanced.

Now, when staying space is formed in the body unit, specification such as a size of the body unit, a weight of the body unit, and equipment of the body unit, may be customized in accordance with the preference of individual users. In this connection, the specification required for the mobile chassis unit may also vary for each target body unit.

Accordingly, in the information processing device according to the present disclosure, when selecting a mobile chassis unit, the control unit first acquires information (specification information) regarding the specification of the target body unit. In that case, the information processing device may include a storage unit for storing data that associates information for identifying individual body units and specification information regarding individual body units. When such a storage unit is provided in the information processing device, the control unit can acquire the specification information regarding the target body unit by accessing the storage unit with use of the identification information on the target body unit as an argument. The specification information may be transmitted from a user's terminal to the information processing device together with the movement request. When the specification information of the target body unit is acquired by these methods, the control unit selects, out of the chassis units in the free state, the chassis unit adapted to the specification information as the mobile chassis unit. When the movement command is transmitted to the mobile chassis unit selected in such a manner, the mobile chassis unit can reliably transport the target body unit from the prescribed place to the prescribed movement destination.

Here, the specification information may also include information regarding the size of the target body unit. In that case, the control unit of the information processing device may select, out of the chassis units in the free state, the chassis unit being sized to be joinable with the target body unit as the mobile chassis. This makes it possible to restrain the situation where the mobile chassis unit is unable to join with the target body unit after the mobile chassis unit arrives at the prescribed place.

The specification information may also include information regarding the weight of the target body unit. In that case, the control unit of the information processing device may select, out of the chassis units in the free state, the chassis unit having a maximum transportation capacity that is equal to or more than the weight of the target body unit as the mobile chassis unit. The term “maximum transportation capacity” herein refers to a maximum weight of the body units that the chassis unit can transport. This makes it possible to restrain the situation where the mobile chassis unit is unable to transport the target body unit after the mobile chassis unit arrives at the prescribed place.

The specification information may also include information regarding equipment mounted on the target body unit (body side equipment). In that case, the control unit of the information processing device may select, out of the chassis units in the free state, the chassis unit mounted with equipment (chassis side equipment) needed for operating the body side equipment as the mobile chassis unit. This makes it possible to restrain the situation where the body side equipment is not usable during movement of the target body unit. In other words, the user of the target body unit can use the body side equipment even during movement of the target body unit.

Here, it may be assumed that there are cases where the chassis unit to be mounted with the chassis side equipment is not present in the chassis units in the free state. In such cases, the control unit of the information processing device may select, out of the chassis units in the free state, any chassis unit as the mobile chassis unit. The control unit may transmit to a prescribed composition base a command (mounting command) for mounting the chassis side equipment on the selected mobile chassis unit. In this connection, the control unit may transmit to the mobile chassis unit a movement command that is a command for moving the target body unit from the prescribed place to the prescribed movement destination after the mobile chassis unit passes through the prescribed composition base. The term “prescribed composition base” herein refers to a base for performing modification, addition, or the like, of the equipment which composes the chassis unit. Examples of the prescribed composition base include a factory that performs check and maintenance of the chassis unit. The mobile chassis unit which has received the movement command moves to the prescribed composition base first. In the prescribed composition base, a work for mounting the chassis side equipment on the mobile chassis unit is performed in accordance with the mounting command. The work in that case may be a work for adding the chassis side equipment to the mobile chassis unit, or may be a work for replacing existing equipment mounted on the mobile chassis unit with the chassis side equipment. Once the chassis side equipment is mounted on the mobile chassis unit, the mobile chassis unit moves from the prescribed composition base to the prescribed place in accordance with the movement command. Then, the mobile chassis unit is joined to the target body unit in the prescribed place, and moves from the prescribed place to the prescribed movement destination. During a movement period from the prescribed place to the prescribed movement destination, the body side equipment becomes usable with the aid of the chassis side equipment newly mounted on the mobile chassis unit.

Here, examples of the body side equipment may include electric equipment and water section equipment. The chassis side equipment when the body side equipment is electric equipment is, for example, power supply equipment (for example, electric generators, batteries, or the like) which can supply electric power to the electric equipment. The chassis side equipment when the body side equipment is water section equipment is, for example, water supply equipment which can supply water to the water section equipment.

The specification information may also include information regarding vibration resistance of the body side equipment. In that case, the control unit of the information processing device may select, out of the chassis units in the free state, the chassis unit having a damping characteristic compatible with the vibration resistance of the body side equipment as the mobile chassis unit. For example, when the vibration resistance of the body side equipment is relatively small, the control unit may select the chassis unit having a relatively large damping characteristic as the mobile chassis unit. This makes it possible to restrain failure in the body side equipment caused by traveling vibration or the like during movement of the target body unit.

When the mobile chassis unit is formed to have a variable damping characteristic, the control unit may transmit, at the time of transmitting the movement command to the mobile chassis unit, a setting command to the mobile chassis unit together with the movement command. The term “setting command” herein refers to a command for setting the damping characteristic of the mobile chassis unit to be compatible with the vibration resistance of the body side equipment. Accordingly, the damping characteristic when the mobile chassis unit transports the target body unit can be set to the characteristic compatible with the vibration resistance of the body side equipment.

The case where the user of the target body unit desires manual driving of the chassis unit may also be assumed. In that case, the control unit of the information processing device may select, out of the chassis units in the free state, the chassis unit adapted to the specification information and switchable between autonomous driving and the manual driving as the mobile chassis unit. This enables the user to make the mobile chassis unit travel by manual driving during a period when the mobile chassis unit transports the target body unit.

Here, it may be assumed that there are cases where a plurality of movement requests may be satisfied more efficiently by one chassis unit in a sequential manner than by a plurality of chassis units in a respective manner. For example, when the information processing device accepts a first movement request and a second movement request, and a prescribed condition is established between these movement requests, the movement requests may be satisfied by one mobile chassis unit. The term “first movement request” herein refers to a request for moving a first target body unit, stationarily disposed in a first prescribed place, from the first prescribed place to a first prescribed movement destination. The term “second movement request” refers to a request for moving a second target body unit, stationarily disposed in a second prescribed place, from the second prescribed place to a second prescribed movement destination. The term “prescribed condition” is to satisfy, for example, the following two conditions.

First condition: a distance between the first prescribed movement destination and the second prescribed place is equal to or less than a prescribed distance.

Second condition: a difference between estimated date and time when the mobile chassis unit arrives at the first prescribed movement destination and estimated date and time when the second target body unit is moved from the second prescribed place is equal to or less than specified time.

The prescribed distance and the specified time are set such that the mobile chassis unit which departed from the first prescribed movement destination can arrive at the second prescribed place by the estimated movement date and time included in the second movement request.

For example, when the prescribed condition is established, the control unit of the information processing device may select, out of the chassis units in the free state, the chassis unit adapted to the specification information of both the first target body unit and the second target body unit as the mobile chassis unit. Then, the control unit may transmit to the mobile chassis unit a continuous movement command that is a movement command for moving the first target body unit and the second target body unit in sequence. This enables one mobile chassis unit to continuously move the first target body unit and the second target body unit in sequence. As a result, more movement requests can be satisfied in the case where the number of the chassis units in the free state is insufficient with respect to the number of the movement requests or the like. It also becomes possible to reduce energy consumption as compared with the case where a plurality of chassis units is operated.

Here, it may be assumed that there are cases when the chassis unit selected as the mobile chassis unit is a possession of an individual user. In such cases, the control unit may transmit a use request that is a request for permission of use of the mobile chassis unit to a terminal used by the user of the mobile chassis unit. When a response signal to the use request is a signal indicating permission of use of the mobile chassis unit, the control unit may transmit a movement command to the mobile chassis unit. This makes it possible to restrain the mobile chassis unit from being used against the user's will, when the mobile chassis unit is a possession of an individual user.

The use request nay include information regarding an incentive that is applied when the use of the mobile chassis unit is permitted. The incentive in that case may include, for example, an expense (electricity expense, fuel expense, road toll, or the like) required when the mobile chassis unit is used for moving the target body unit, and a reward. This makes it possible to motivate the user of the mobile chassis unit to give permission of use of the mobile chassis unit. When the response signal to the use request is a signal indicating non-permission of use of the mobile chassis unit, the control unit may select a chassis unit different from the previously selected mobile chassis unit as a new mobile chassis unit. Then, the control unit may transmit the same use request as the previous use request to the terminal used by the user of the newly selected mobile chassis unit.

Here, the movement request may include, for example, information indicating the location of the prescribed place, information indicating the location of the prescribed movement destination, and information indicating the estimated movement date and time (estimated date and time for moving the body unit from the prescribed place). Hence, the information processing device can ascertain the location of the target body unit (location of the prescribed place), the movement destination of the target body unit (location of the prescribed movement destination), and the estimated movement date and time of the target body unit. Then, the control unit of the information processing device can control operation of the mobile chassis unit based on the movement request. At the time, the control unit can transmit, for example, a movement command including the following three commands to the mobile chassis unit.

First command: a command for making the mobile chassis unit travel such that the mobile chassis unit arrives at the prescribed place by the estimated movement date and time.

Second command: a command for joining the mobile chassis unit with the target body unit in the prescribed place.

Third command: a command for making the mobile chassis unit travel from the prescribed place to the prescribed movement destination.

Fourth command: a command for separating the mobile chassis unit from the target body unit in the prescribed movement destination.

When the mobile chassis unit receives the movement command including the first to fourth commands, the mobile chassis unit first travels autonomously by autonomous driving in accordance with the first command so as to move to the prescribed place by the estimated movement date and time. The mobile chassis unit which has arrived at the prescribed place operates in accordance with the second command so as to join the mobile chassis unit with the target body unit stationarily disposed in the prescribed place. A work for joining the mobile chassis unit and the target body unit may be conducted by an external device mounted with a heavy machinery, such as a lift, a crane, or the like. Alternatively, the work for joining the mobile chassis unit and the target body unit may be conducted by a device mounted on the mobile chassis unit or the target body unit. When the mobile chassis unit and the target body unit are joined in such a manner, the mobile chassis unit travels autonomously by autonomous driving in accordance with the third command so as to move from the prescribed place to the prescribed movement destination. As a result, the target body unit is transported from the prescribed place to the prescribed movement destination. When the mobile chassis unit arrives at the prescribed movement destination, a work for separating the mobile chassis unit and the target body unit is conducted. The work for separating the mobile chassis unit and the target body unit may be conducted by an external device as described above, or may be conducted by a device mounted on the mobile chassis unit or the target body unit. Thus, the mobile chassis unit can move the target body unit from the prescribed place to the prescribed movement destination.

Hereinafter, specific embodiments of the present disclosure will be described with reference to the drawings. Note that sizes, materials, shapes, and relative arrangements of component members disclosed in the embodiments are not intended to restrict the technical ranges of the present disclosure thereto unless otherwise specified.

### First Embodiment

In a first embodiment, description is given of an example where an information processing device according to the present disclosure is applied to a system for chassis unit sharing service (which may be stated as “sharing management system” below).

Summary of Sharing Management System

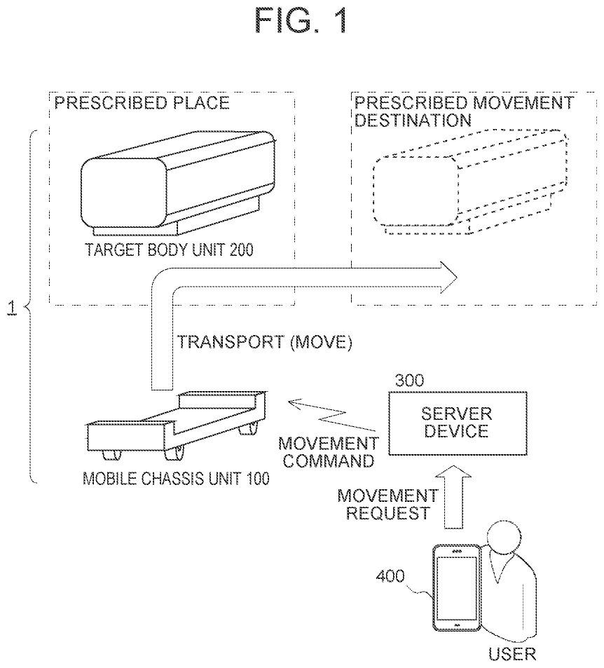

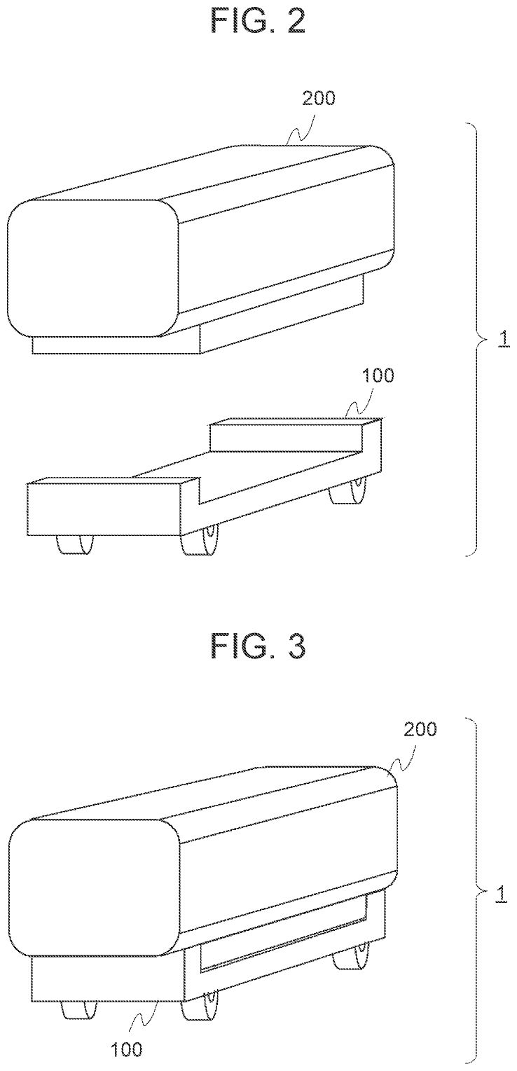

FIG. 1 is a schematic view showing the sharing management system. The sharing management system in the present example is configured by including separable vehicles 1 and a server device 300. The separable vehicle 1 includes a chassis unit 100 and a body unit 200 as shown in FIGS. 2 and 3. In the example shown in FIGS. 1 to 3, one chassis unit 100 and one body unit 200 are illustrated. However, two or more chassis units 100 and body units 200 may be provided under management of the server device 300.

The chassis unit 100 is a unit that can autonomously travel on a road by autonomous driving. The chassis unit 100 may include a riding space for a user to perform manual driving. The body unit 200 is a unit that is unable to travel on a road by itself. The body unit 200 in the present example includes space (staying space) used by a user when the user stays at a prescribed place. As expressed in FIGS. 2 and 3, the chassis unit 100 and the body unit 200 are formed to be freely joined to and separated from each other. FIG. 2 shows the state where the chassis unit 100 and the body unit 200 are separated. FIG. 3 shows the state where the chassis unit 100 and the body unit 200 are joined.

Here, the body unit 200 including the staying space is used in the case where the user stays at a prescribed place, or in other cases. Specifically, the body unit 200 including the staying space is stationarily disposed in a prescribed place during a period when the user stays at the prescribed place. In the present example, since the chassis unit 100 is shared by the body units 200, the body units 200 are stationarily disposed in prescribed places in the state of being separated from the chassis unit 100. When one of the body units 200 stationarily disposed in its prescribed place is moved to a movement destination (prescribed movement destination) that the user desires from the prescribed place, the chassis unit 100 in the free state is used to move (transport) the body unit 200. The term “free state” herein refers to the state where the chassis unit 100 is separated from the body unit, i.e., the state where the chassis unit 100 is not joined to any body units. The work for moving the body unit 200 is conducted with a movement request transmitted from a user terminal 400 to the server device 300 as a trigger. The term “user terminal 400” herein refers to, for example, a terminal used by the user of the body unit 200 (target body unit 200) that is the target of the movement. The user terminal 400 may be a small-sized computer that the user can carry, such as a smartphone, a cellular phone, a tablet computer, a personal information terminal, or a wearable computer (smartwatch, etc.) carried by the user. The user terminal 400 may be a personal computer (PC) connected to the server device 300 through networks, such as the Internet that is a public communication network. The server device 300 which has received the movement request selects, out of the chassis units 100 under management of the server device 300, the chassis unit 100 (mobile chassis unit 100) for moving the target body unit 200. Specifically, out of the chassis units 100 under management of the server device 300, the chassis unit 100 that is in a free state and that is adapted to specifications of the target body unit 200 is selected as the mobile chassis unit. Then, the server device 300 transmits a movement command to the selected mobile chassis unit 100. The movement command in the present example is a command for moving the target body unit from the prescribed place to the prescribed movement destination. The mobile chassis unit 100 which has received such a movement command operates in accordance with the movement command so as to transport the target body unit 200 from the prescribed place to the prescribed movement destination.

Hardware Configuration of Sharing Management System

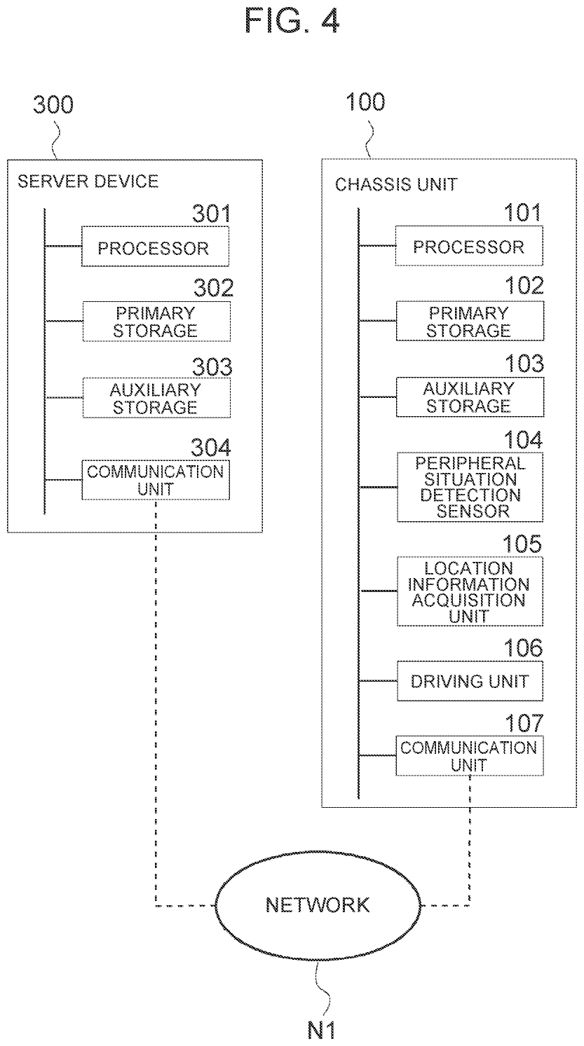

Now, component members of a sharing control system will be described in detail. FIG. 4 shows a hardware configuration example of the chassis unit 100 and the server device 300 that are shown in FIG. 1.

The chassis unit 100 travels autonomously on a road in accordance with a prescribed operation command. The chassis unit 100 is configured by including a processor 101, a primary storage 102, an auxiliary storage 103, a peripheral situation detection sensor 104, a location information acquisition unit 105, a driving unit 106, and a communication unit 107. The chassis unit 100 in the present example is an electric vehicle driven by using an electric motor as a motor. Without being limited to the electric motor, the motor of the chassis unit 100 may be an internal combustion engine or a hybrid mechanism of the internal combustion engine and the electric motor.

For example, the processor 101 is a central processing unit (CPU), or a digital signal processor (DSP). The processor 101 controls the chassis unit 100 and performs various information processing computations. For example, the primary storage 102 includes a random-access memory (RAM), and a read-only memory (ROM). For example, the auxiliary storage 103 is an erasable programmable ROM (EPROM), or a hard disk drive (HDD). The auxiliary storage 103 may include a removable medium, i.e., a portable recording medium. For example, the removable medium is a universal serial bus (USB) memory, or a disc recording medium such as a compact disc (CD) and a digital versatile disc (DVD).

The auxiliary storage 103 stores various kinds of programs, various kinds of data, and various kinds of tables in a recording medium in a readable and writable manner. The auxiliary storage 103 stores an operating system (OS), various programs, various tables, and the like. Some or all of these pieces of information may be stored in the primary storage 102. The information stored in the primary storage 102 may be stored in the auxiliary storage 103.

The peripheral situation detection sensor 104 is one or more sensors for sensing the periphery of the vehicle. The peripheral situation detection sensor 104 is typically configured by including a stereoscopic camera, a laser scanner, a LIDAR, or a radar. The information acquired by the peripheral situation detection sensor 104 is delivered to the processor 101.

The location information acquisition unit 105 is a device for acquiring a current location of the chassis unit 100. The location information acquisition unit 105 is typically configured by including a GPS receiver. The location information acquisition unit 105 in the present example acquires the current location of the chassis unit 100 in a predetermined cycle. The location information acquired by the location information acquisition unit 105 is transmitted to the server device 300 through the communication unit 107 described later. In other words, the location information on the chassis unit 100 is transmitted from the chassis unit 100 to the server device 300 in a predetermined cycle. Thus, the server device 300 can ascertain the current location of each of the chassis units 100.

The driving unit 106 is a device for making the chassis unit 100 travel. The driving unit 106 is configured by including, for example, an electric motor as a motor, a battery for supplying electricity to the electric motor, a braking device for braking the chassis unit 100, and a steering device for changing the steering angle of the wheels of the chassis unit 100.

The communication unit 107 is a device for connecting the chassis unit 100 to a network N1. The communication unit 107 uses, for example, a mobile communications system, such as a 5th generation (5G) mobile communications system, a long term evolution (LTE) mobile communications system, or the like, to connect with the network N1. The communication unit 107 may use a narrow band communication system, such as a dedicated short range communications (DSRC) or Wi-Fi (registered trademark) communications system to connect with the network N1. Accordingly, the communication unit 107 can communicate with other devices (for example, the body unit 200, the server device 300 or the like) via the network N1 . For example, the communication unit 107 transmits the current location information, or the like, acquired by the location information acquisition unit 105 to the server device 300 via the network N1. The network N1 herein refers to, for example, a wide area network (WAN) that is a worldwide public communications network such as the Internet, or other communications networks.

The hardware configuration of the chassis unit 100 is not limited to the example shown in FIG. 4, and the component members of the chassis unit 100 may suitably be omitted, replaced or added. For example, the chassis unit 100 may be mounted with a device for conducting the works for joining and separating the chassis unit 100 and the body unit 200. Such a device may be a heavy machinery equipped with a lift or a crane, or an electromagnet, for example. While a series of processes executed in the chassis unit 100 can also be executed by hardware, the processes can also be executed by software.

The server device 300 is a device for managing the separable vehicles 1 (the chassis units 100 and the body units 200), and corresponds to the “information processing device” according to the present disclosure. The server device 300 has the configuration of a general computer. Specifically, the server device 300 is configured by including a processor 301, a primary storage 302, an auxiliary storage 303, and a communication unit 304. The processor 301, the primary storage 302, the auxiliary storage 303, the communication unit 304, and the like are connected with each other via a bus. Since the processor 301, the primary storage 302, and the auxiliary storage 303 are similar to those of the chassis unit 100, the description thereof is omitted. The communication unit 304 performs information transmission and reception between an external device and the server device 300. The communication unit 304 is, for example, a local area network (LAN) interface board, or a wireless communication circuit for wireless communication. The LAN interface board or the wireless communication circuit is connected to the network N1.

The hardware configuration of the server device 300 is not limited to the example shown in FIG. 4, and the component members of the server device 300 may suitably be omitted, replaced or added. Although a series of processes executed in the server device 300 can be executed by hardware, the processes can also be executed by software.

Functional Configuration of Chassis Unit

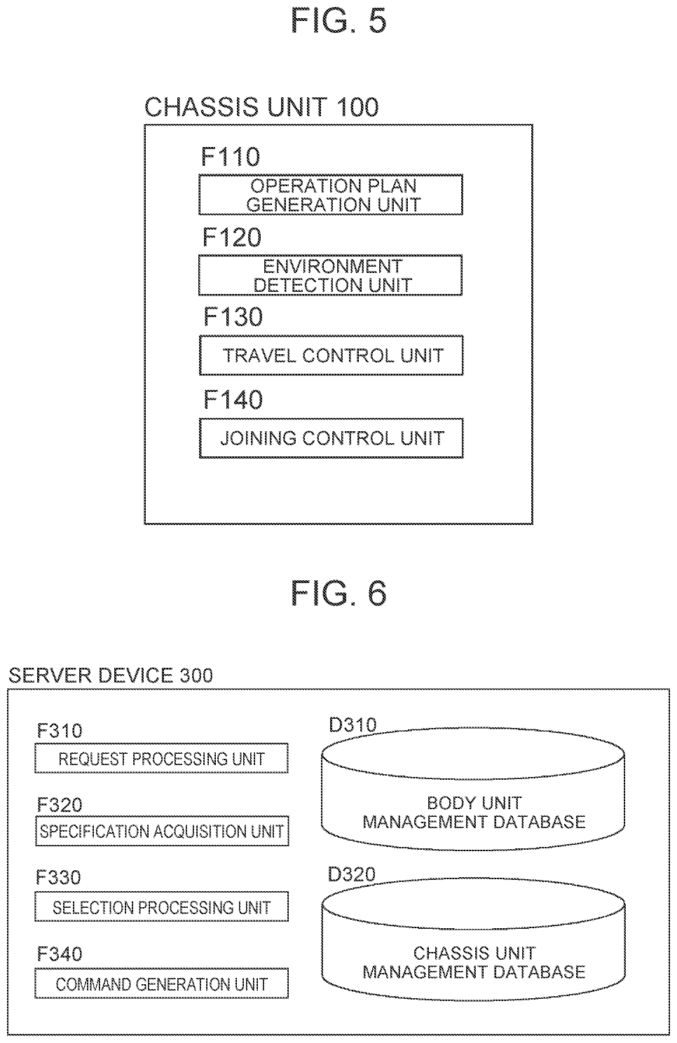

Here, the functional configuration of the chassis unit 100 will be described based on FIG. 5. The chassis unit 100 in the present example includes, as shown in FIG. 5, an operation plan generation unit F110, an environment detection unit F120, a travel control unit F130, and a joining control unit F140 as functional components. These functional components are implemented when the processor 101 executes programs stored in the primary storage 102 or the auxiliary storage 103. Any one or some of the operation plan generation unit F110, the environment detection unit F120, the travel control unit F130, and the joining control unit F140 may be formed with a hardware circuit. Any one of the functional components or some of the processes thereof may be executed by other computers connected to the network N1. For example, processes included in the operation plan generation unit F110, processes included in the environment detection unit F120, processes included in the travel control unit F130, and processes included in the joining control unit F140 may be executed by different computers, respectively.

The operation plan generation unit F110 generates an operation plan of the chassis unit 100 based on an operation command from the server device 300. The operation plan is data which defines a route on which the chassis unit 100 travels and which defines the processes to be performed by the chassis unit 100 in some part of the route or in the entire route. Examples of the data included in the operation plan may include the following data.

(1) Data indicating a route (scheduled travel route) that the chassis unit 100 is scheduled to travel, the route being expressed as a group of road links.

The “scheduled travel route” stated herein may be generated by the operation plan generation unit F110 based on a command from the server device 300 with reference to map data stored in the auxiliary storage 103 or the like. The “scheduled travel route” may be generated using an external service, or may be provided from the server device 300.

(2) Data indicating the process to be performed by the chassis unit 100 in any points on the scheduled travel route.

The “any points” herein refer to places, such as a place for separating and joining the chassis unit 100 and the body unit 200. Examples of the process performed by the chassis unit 100 at any points as described above may include “separating or joining the chassis unit 100 and the body unit 200”. However, the process is not limited to this.

The environment detection unit F120 detects the environment around the chassis unit based on the data acquired by the peripheral situation detection sensor 104. Examples of detection targets include the number and location of lanes, the number and location of vehicles present around the chassis unit 100, the number and location of obstacles present around the chassis unit 100, the structure of roads, and road signs. However, the detection targets are not limited to these. The detection targets may be any objects as long as they are necessary for the chassis unit 100 to travel autonomously. The environment detection unit F120 may also track a detected object. For example, a relative speed of the object may be obtained from a difference between coordinates of the object detected one step before and current coordinates of the object.

The travel control unit F130 controls travel of the chassis unit 100 based on the operation plan generated by the operation plan generation unit F110, the environment data generated by the environment detection unit F120, and the location information on the chassis unit 100 acquired by the location information acquisition unit 105. For example, the travel control unit F130 makes the chassis unit 100 travel along a scheduled travel route generated by the operation plan generation unit F110. In this case, the travel control unit F130 makes the chassis unit 100 travel such that no obstacle enters the inside of a prescribed safety area around the chassis unit 100. As a method of implementing autonomous travel of the chassis unit 100, a publicly-known method may be adopted. The travel control unit F130 also has a function of controlling the travel of the chassis unit 100 in accordance with a command from the server device 300.

The joining control unit F140 controls joining and separation of the chassis unit 100 and the body unit 200. When the works for joining and separating the chassis unit 100 and the body unit 200 are conducted by an external device, the joining control unit F140 controls the external device through a wireless communication or the like, so that the joining and separation works of the chassis unit 100 and the body unit 200 are conducted. When the device for joining and separating the chassis unit 100 and the body unit 200 is mounted on the chassis unit 100, the joining control unit F140 controls the device, so that the joining and separation works of the chassis unit 100 and the body unit 200 are conducted. Functional Configuration of Server Device

Next, the functional configuration of the server device 300 will be described based on FIG. 6. For example, the server device 300 in the present example includes, as shown in FIG. 6, a request processing unit F310, a specification acquisition unit F320, a selection processing unit F330, a command generation unit F340, a body unit management database D310, and a chassis unit management database D320 as the functional components. The request processing unit F310, the specification acquisition unit F320, the selection processing unit F330, and the command generation unit F340 are implemented when the processor 301 executes programs stored in the primary storage 302 or the auxiliary storage 303. Any one or some of the request processing unit F310, the specification acquisition unit F320, the selection processing unit F330, and the command generation unit F340 may be formed with a hardware circuit. Any one of the request processing unit F310, the specification acquisition unit F320, the selection processing unit F330, and the command generation unit F340 or some of the processes thereof may be executed by other computers connected to the network N1. For example, processes included in the request processing unit F310, processes included in the specification acquisition unit F320, processes included in the selection processing unit F330, and processes included in the command generation unit F340 may be executed by different computers, respectively.

The body unit management database D310 and the chassis unit management database D320 are constructed with programs of a database management system (DBMS) executed by the processor 301. Specifically, the programs of the DBMS manages the data stored in the auxiliary storage 303, so that the body unit management database D310 and the chassis unit management database D320 are constructed. The body unit management database D310 and the chassis unit management database D320 constructed in such a manner are relational databases, for example.

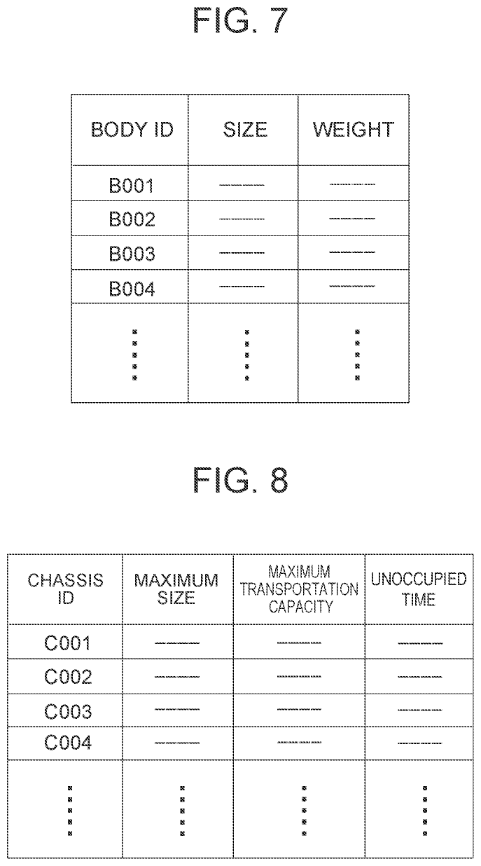

The body unit management database D310 stores information regarding the body units 200 under management of the server device 300. In the body unit management database D310, the body units 200 and specification information are associated. Here, examples of the information stored in the body unit management database D310 will be described based on FIG. 7. FIG. 7 shows a table configuration of the information stored in the body unit management database D310. Here, description is given of an example where information regarding the size of the body units 200 and information regarding the weight of the body units 200 are used as the specification information regarding the body units 200. The table stored in the body unit management database D310 (which may be stated as “body unit information table “below) is not limited to the configuration shown in FIG. 7. Fields of the table may suitably be added, modified, or deleted.

The body unit information table shown in FIG. 7 has fields of a body ID, a size, and a weight. In the body ID field, information (which may also be stated as “body ID” below) for identifying each of the body units 200 under management of the server device 300 is stored. In the size field, information regarding the size (length and width) of each of the body units 200 is registered. In the weight field, information regarding the weight of each of the body units 200 is registered.

The chassis unit management database D320 stores information regarding the chassis units 100 under management of the server device 300. In the chassis unit management database D320, the chassis units 100, specification information, and the state of the chassis units 100 are associated. Here, examples of the information stored in the chassis unit management database D320 will be described based on FIG. 8. FIG. 8 illustrates a table configuration of the chassis unit management database D320. Here, description is given of an example where, information regarding a maximum size of the body unit that the chassis unit 100 can transport, and information regarding a maximum transportation capacity corresponding to the maximum weight of the chassis unit 100 that the chassis unit 100 can transport are used as the specification information of the chassis unit 100. The table stored in the chassis unit management database D320 (which may be stated as “chassis unit information table” below) is not limited to the example shown in FIG. 8. Fields of the table may suitably be added, modified, or deleted.

The chassis unit information table shown in FIG. 8 has fields of a chassis ID, a maximum size, a maximum transportation capacity, and unoccupied time. In the chassis ID field, information (which may also be stated as “chassis ID” below) for identifying each of the chassis units 100 under management of the server device 300 is registered. In the maximum size field, information regarding the maximum size of the body units that each of the chassis units 100 can transport is registered. The maximum size is a maximum length and a maximum width of the body unit that the chassis unit 100 can transport. In the maximum transportation capacity field, information regarding the maximum transportation capacity of the chassis units 100 is registered. The maximum transportation capacity is the maximum weight of the body units that the chassis unit 100 can transport. In the unoccupied time field, date and time when each of the chassis units 100 is available as the mobile chassis unit 100 (information regarding date and time when each of the chassis units 100 is unoccupied, which may also be stated as “unoccupied time” below) are registered.

The request processing unit F310 accepts the movement request transmitted from the user terminal 400. In the present example, the reception of the movement request is achieved by receiving the movement request transmitted from the user terminal 400 to the server device 300 through the communication unit 304. The movement request in that case includes, for example, the body ID of the target body unit 200, information indicating the location of a place (prescribed place) where the target body unit 200 is stationarily disposed, information indicating the location of a movement destination (prescribed movement destination) of the target body unit 200, and information indicating estimated movement date and time. The information indicating the location of the prescribed place, and the information indicating the prescribed movement destination may be information indicating the addresses of the prescribed place and the prescribed movement destination, or may be information indicating the coordinates (latitude and longitude) of the prescribed place and the prescribed movement destination on a map.

The specification acquisition unit F320 acquires the specification information (size information and weight information) of the target body unit 200. In the present example, the specification acquisition unit F320 first accesses the body unit management database D310 with the body ID of the target body unit 200 as an argument so as to identify the body unit information table corresponding to the target body unit 200. Next, the specification acquisition unit F320 extracts the information (size information and weight information) registered into the size field and the weight field in the identified body unit information table so as to acquire the specification information regarding the target body unit 200.

The selection processing unit F330 selects the mobile chassis unit 100 out of the chassis units 100 under management of the server device 300. In the present example, the selection processing unit F330 first accesses the chassis unit management database D320 to extract the chassis unit information tables in which the unoccupied time adapted to the estimated movement date and time of the target body unit 200 is registered into the unoccupied time field. Thus, the chassis units 100 that are to be in the free state at the estimated movement date and time of the target body unit 200 are extracted. Next, the selection processing unit F330 selects, out of the extracted chassis units 100, the chassis unit 100 adapted to the specification information regarding the target body unit 200, as the mobile chassis unit 100. Specifically, the selection processing unit F330 first identifies, out of the extracted chassis unit information tables, the chassis unit information tables in which the maximum size equal to or more than the size of the target body unit 200 is registered into the maximum size field. Next, the selection processing unit F330 identifies, out of the identified chassis unit information tables, the chassis unit information tables in which the maximum transportation capacity that is equal to or more than the weight of the target body unit 200 is registered into the maximum transportation capacity field. Accordingly, out of the chassis units 100 which are to be in the free state at the estimated movement date and time of the target body unit 200, the chassis unit 100 having the maximum size that is equal to or more than the size of the target body unit 200 and having the maximum transportation capacity that is equal to or more than the weight of the target body unit 200 is identified. The thus-identified chassis unit 100 is selected as the mobile chassis unit 100.

The command generation unit F340 generates a command (movement command) for moving the target body unit 200 from the prescribed place to the prescribed movement destination. The movement command in that case includes, for example, the following first to fourth commands.

First command: a command for making the mobile chassis unit 100 travel such that the mobile chassis unit 100 arrives at the prescribed place by the estimated movement date and time.

Second command: a command for joining the mobile chassis unit 100 with the target body unit 200 at the prescribed place.

Third command: a command for making the mobile chassis unit 100 travel from the prescribed place to the prescribed movement destination.

Fourth command: a command for separating the mobile chassis unit 100 from the target body unit 200 at the prescribed movement destination.

The movement command generated by the command generation unit F340 is transmitted to the mobile chassis unit 100 selected by the selection processing unit F330 through the communication unit 304.

Process Flow

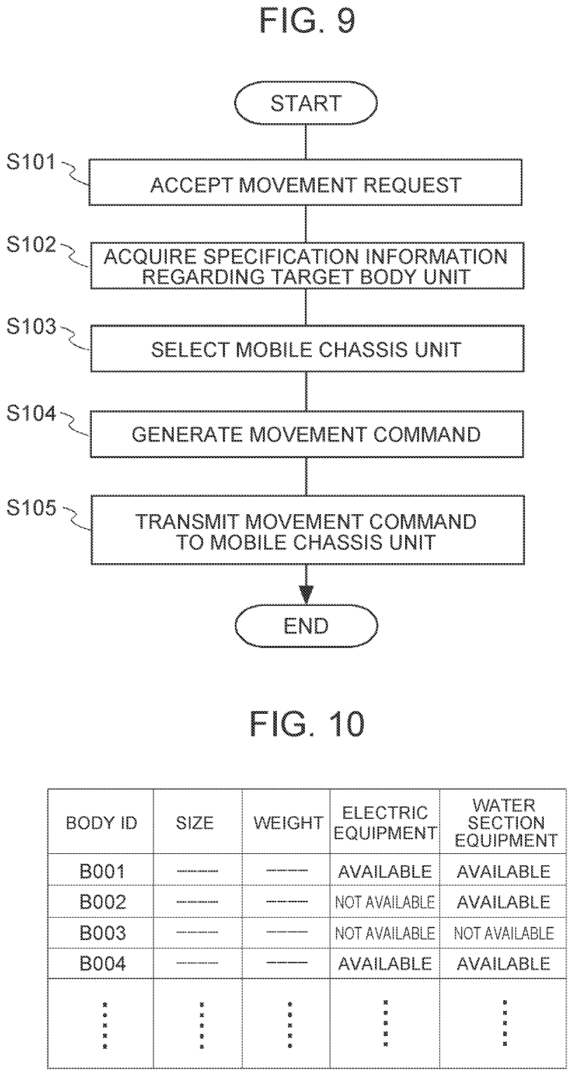

Next, the flow of a process performed in the server device 300 in the present embodiment will be described based on FIG. 9. FIG. 9 is a flowchart showing the flow of the process performed in the server device 300 with reception of the movement request transmitted from the user terminal 400 as a trigger.

In FIG. 9, when the communication unit 304 of the server device 300 receives a movement request from the user terminal 400, the request processing unit F310 accepts the movement request (step S101) The request processing unit F310 extracts the body ID of the target body unit 200, the information indicating the location of the prescribed place, the information indicating the location of the prescribed movement destination, and the information indicating estimated movement date and time from the movement request. The information extracted by the request processing unit F310 is delivered from the request processing unit F310 to the specification acquisition unit F320.

The specification acquisition unit F320 acquires the specification information regarding the target body unit 200 based on the information delivered from the request processing unit F310 (step S102). Specifically, the specification acquisition unit F320 accesses the body unit management database D310 with the body ID delivered from the request processing unit F310 as an argument, so as to identify the body unit information table corresponding to the target body unit 200. Next, the specification acquisition unit F320 extracts the information (size and weight) registered into the size field and the weight field in the identified body unit information table, so as to acquire the specification information regarding the target body unit 200. The specification information acquired by the specification acquisition unit F320 is delivered from the specification acquisition unit F320 to the selection processing unit F330, together with the location information on the prescribed place, the location information on the prescribed movement destination, and the information indicating the estimated movement date and time.

The selection processing unit F330 selects the mobile chassis unit 100 based on the information delivered from the specification acquisition unit F320 (step S103). Specifically, the selection processing unit F330 first accesses the chassis unit management database D320 to extract the chassis unit information tables in which the unoccupied time adapted to the estimated movement date and time is registered into the unoccupied time field (first process). The selection processing unit F330 identifies, out of the chassis unit information tables extracted in the first process, the chassis unit information tables in which the maximum size that is equal to or more than the size of the target body unit 200 is registered into the maximum size field (second process). The selection processing unit F330 identifies, out of the chassis unit information tables identified in the second process, the chassis unit information tables in which the maximum transportation capacity that is equal to or more than the weight of the target body unit 200 is registered into the maximum transportation capacity field (third process). Then, the selection processing unit F330 determines the chassis unit 100 corresponding to the chassis unit information table identified in the third process as the mobile chassis unit. Thus, the chassis unit 100 which satisfies the condition for moving the target body unit 200 is selected as the mobile chassis unit. The chassis ID of the mobile chassis unit 100 is delivered from the selection processing unit F330 to the command generation unit F340, together with the location information on the prescribed place, the location information on the prescribed movement destination, and the information indicating the estimated movement date and time.

The command generation unit F340 generates a movement command to the mobile chassis unit 100 (step S104). The movement command is a command including the first to fourth commands. The movement command generated by the command generation unit F340 is transmitted to the mobile chassis unit 100 through the communication unit 304 (step S105).

In the mobile chassis unit 100 which has received the movement command, the operation plan generation unit F110 generates an operation plan based on the movement command. As described before, the operation plan includes the data on the scheduled travel route of the mobile chassis unit 100 expressed as a group of the road links, and the data indicating the process to be performed by the chassis unit 100 at any points on the scheduled travel route. The scheduled travel route in the present example includes a route extending from a departure point of the mobile chassis unit 100 to the prescribed movement destination via the prescribed place. Any points on the scheduled travel route include the prescribed place and the prescribed movement destination. The process to be performed by the mobile chassis unit 100 at the prescribed place includes the process of joining the mobile chassis unit 100 with the target body unit 200. The process to be performed by the mobile chassis unit 100 at the prescribed movement destination includes the process of separating the mobile chassis unit 100 from the target body unit 200. When such an operation plan is generated, the travel control unit F130 of the mobile chassis unit 100 starts travel of the mobile chassis unit 100 at such a timing that the mobile chassis unit 100 arrives at the prescribed place by the scheduled movement date. At the time, the travel control unit F130 controls the driving unit 106 based on the scheduled travel route, the environment data generated by the environment detection unit F120, and the location information acquired by the location information acquisition unit 105, so that the travel of the mobile chassis unit 100 is controlled. Thus, the mobile chassis unit 100 can travel autonomously by autonomous driving from the departure point to the prescribed place. When the mobile chassis unit 100 arrives at the prescribed place, the joining control unit F140 controls the aforementioned external device or the device mounted on the chassis unit 100, so as to join the mobile chassis unit 100 with the target body unit 200. Once the work for joining the mobile chassis unit 100 and the target body unit 200 is completed, the travel control unit F130 resumes travel of the mobile chassis unit 100. At the time, the travel control unit F130 controls the driving unit 106 based on the scheduled travel route, the environment data generated by the environment detection unit F120, and the location information acquired by the location information acquisition unit 105, so as to control travel of the mobile chassis unit 100. As a result, the mobile chassis unit 100 can travel autonomously by autonomous driving from the prescribed place to the prescribed movement destination. When the mobile chassis unit 100 arrives at the prescribed movement destination, the joining control unit F140 controls the aforementioned external device or the device mounted on the chassis unit 100, so as to separate the mobile chassis unit 100 from the target body unit 200. By operating the mobile chassis unit 100 in such a manner, the target body unit 200 stationarily disposed in the prescribed place can be transported from the prescribed place to the prescribed movement destination.

According to the process flow shown in FIG. 9, when it is needed to move the body unit 200 stationarily disposed in a prescribed place, the work for moving the body unit 200 can be performed by using the chassis unit 100 in the free state. This makes it possible to share the chassis unit 100 among the body units 200. Therefore, in the case where the body units 200 are stationarily disposed in prescribed places over a relatively long period of time, it becomes unnecessary to stationarily dispose the body units 200 in the state of being joined to the chassis units 100. It also becomes unnecessary for the users of the body units 200 to individually own the chassis units 100. As a result, the utilization efficiency of the chassis units can be enhanced.

### First Modification of First Embodiment

The body unit 200 including staying space may be mounted with body side equipment, such as electric equipment or water section equipment. When the body unit 200 mounted with the body side equipment is moved as a target body unit, and the mobile chassis unit 100 is not mounted with chassis side equipment, such as power supply equipment or water supply equipment, there is a possibility that the body side equipment is not usable during the movement. This may damage the convenience of the user of the body unit 200. To cope with this situation, in the present modification, the mobile chassis unit 100 is selected in consideration of the body side equipment of the target body unit 200.

Here, a configuration example of the body unit information table in the present modification is shown in FIG. 10. The body unit information table in the present modification has an electric equipment field and a water section equipment field, in addition to the fields of the body ID, the size, and the weight as shown in FIG. 10. In the electric equipment field, information indicating whether each of the body units 200 is mounted with the electric equipment is registered. For example, when the electric equipment is mounted on the body unit 200, “available” is registered in the electric equipment field. When the electric equipment is not mounted on the body unit 200, “not available” is registered in the electric equipment field. The term “electric equipment” herein refers to equipment operable by electric power supplied from the outside. Examples of the electric equipment include lighting equipment, air-conditioners, refrigerators, or IH cooking appliances. In the water section equipment field, information indicating whether or not each of the body units 200 is mounted with the water section equipment is registered. For example, when the water section equipment is mounted on the body unit 200, “available” is registered in the water section equipment field. When the water section equipment is not mounted on the body unit 200, “not available” is registered in the water section equipment field. The term “water section equipment” herein refers to equipment operable with water supplied from the outside. Examples of the water section equipment include kitchens, toilets, washrooms, or bathrooms.

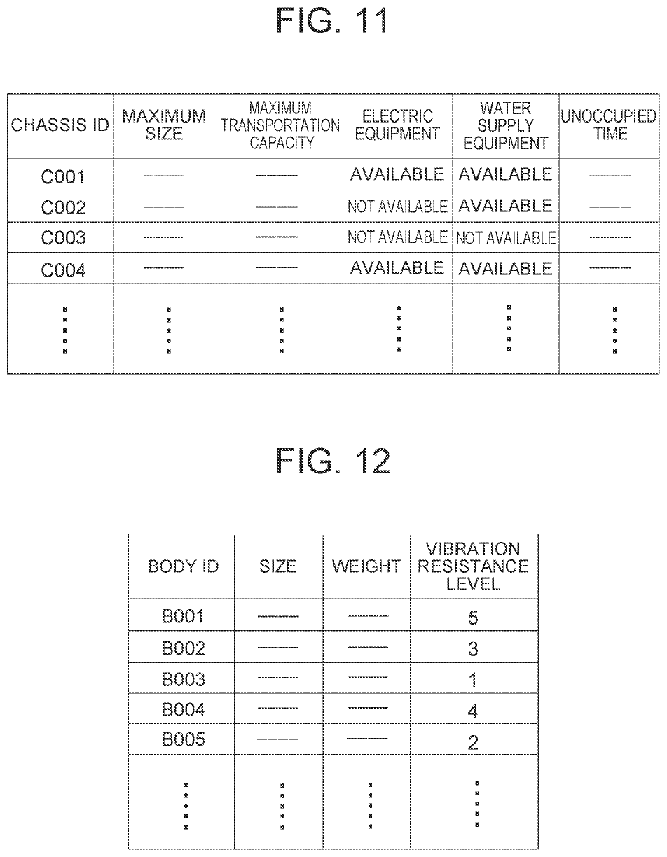

Next, a configuration example of the chassis unit information table in the present modification is shown in FIG. 11. The chassis unit information table in the present modification has a power supply equipment field and a water supply equipment field, in addition to the fields of the chassis ID, the maximum size, the maximum transportation capacity, and the unoccupied time as shown in FIG. 11. In the power supply equipment field, information indicating whether or not each of the chassis units 100 is mounted with the power supply equipment is registered. For example, when the power supply equipment is mounted on the chassis unit 100, “available” is registered in the power supply equipment field. When the power supply equipment is not mounted on the chassis unit 100, “not available” is registered in the power supply equipment field. In the water supply equipment field, information indicating whether or not each of the chassis units 100 is mounted with the water supply equipment is registered. For example, when the water supply equipment is mounted on the chassis unit 100, “available” is registered in the water supply equipment field. When the water supply equipment is not mounted on the chassis unit 100, “not available” is registered in the water supply equipment field.

In the case of selecting the mobile chassis unit 100 in the present modification, the selection processing unit F330 selects the mobile chassis unit 100 in consideration of the body side equipment, in addition to the size and weight of the target body unit 200. For example, when the target body unit 200 is mounted with only the power supply equipment, the selection processing unit F330 selects, out of the chassis units 100 to be in the free state at estimated movement date and time, the chassis unit 100 having the maximum size and the maximum transportation capacity adapted to the target body unit 200 and being mounted with the power supply equipment, as the mobile chassis unit. In this case, the mobile chassis unit may be mounted with or may not be mounted with the water supply equipment. When the target body unit 200 is mounted with only the water supply equipment, the selection processing unit F330 selects, out of the chassis units 100 to be in the free state at the estimated movement date and time, the chassis unit 100 having the maximum size and the maximum transportation capacity adapted to the size and weight of the target body unit 200 and being mounted with the water supply equipment, as the mobile chassis unit. In this case, the mobile chassis unit may be mounted with or may not be mounted with the power supply equipment. When the target body unit 200 is mounted with the power supply equipment and the water supply equipment, the selection processing unit F330 selects, out of the chassis units 100 to be in the free state at the estimated movement date and time, the chassis unit 100 having the maximum size and the maximum transportation capacity adapted to the target body unit 200 and being mounted with the power supply equipment and the water supply equipment, as the mobile chassis unit. When the target body unit 200 is mounted with neither the power supply equipment nor the water supply equipment, the selection processing unit F330 may select the mobile chassis unit in the same procedure as in the aforementioned embodiment.

Now, it is also assumed that there are cases where the chassis unit 100 mounted with the chassis side equipment adapted to the body side equipment of the target body unit 200 is not present in the chassis units 100 to be in the free state at the estimated movement date and time of the target body unit 200. In such a case, out of the chassis units 100 to be in the free state at the estimated movement date and time of the target body unit 200, any one chassis unit may be selected as the mobile chassis unit, and customization of the selected mobile chassis unit may be performed. The term “customization” herein refers to the work of mounting the chassis side equipment, which is adapted to the body side equipment of the target body unit 200, on the mobile chassis unit in a prescribed composition base. The term “prescribed composition base” herein refers to a base for performing modification, addition, or the like, of the equipment which composes the chassis unit 100. Examples of the prescribed composition base include a factory that performs check and maintenance of the chassis unit 100.

When the above-stated customization is needed, the selection processing unit F330 may transmit a mounting command to the prescribed composition base. The term “mounting command” refers to a command for mounting the chassis side equipment, which is adapted to the body side equipment of the target body unit 200, on the mobile chassis unit 100. With the generation of the mounting command, the command generation unit F340 may generate a movement command including the following fifth to ninth commands, and may transmit the generated movement command to the mobile chassis unit 100.

Fifth command: a command for making the mobile chassis unit 100 travel such that the mobile chassis unit 100 arrives at the prescribed composition base before the estimated movement date and time.

Sixth command: a command for making the mobile chassis unit 100 travel such that the mobile chassis unit 100 arrives at the prescribed place by the estimated movement date and time.

Seventh command: a command for joining the mobile chassis unit 100 with the target body unit 200 at the prescribed place.

Eighth command: a command for making the mobile chassis unit 100 travel from the prescribed place to the prescribed movement destination.

Ninth command: a command for separating the mobile chassis unit 100 from the target body unit 200 at the prescribed movement destination.

The mobile chassis unit 100 which has received the movement command as described above is movable to the prescribed composition base before the estimated movement date and time. In the prescribed composition base, the work for mounting the chassis side equipment, which is adapted to the body side equipment of the target body unit 200, on the mobile chassis unit 100 is conducted in accordance with the aforementioned mounting command. Once the work is completed, the mobile chassis unit 100 operates in accordance with the sixth to ninth commands. Hence, the target body unit 200 is transported from the prescribed place to the prescribed movement destination.

When the above-stated customization is unnecessary, the command generation unit F340 may generate a movement command including the first to fourth commands as in the aforementioned embodiment, and may transmit the generated movement command to the mobile chassis unit 100.

According to the present modification, the user of the target body unit 200 can use the body side equipment during the period when the target body unit 200 is moved by the mobile chassis unit 100. Therefore, the convenience of the user of the target body unit 200 can be enhanced.

### Second Modification of First Embodiment

There are cases where the body unit 200 including staying space is mounted with body side equipment having a small vibration resistance, such as precision instruments or cupboards. When such a body unit 200 is moved as the target body unit, and the mobile chassis unit 100 to be used has a small damping characteristic, failure of the body side equipment as described before may possibly be induced. To cope with this situation, in the present modification, the mobile chassis unit 100 is selected in consideration of the vibration resistance of the body side equipment mounted on the target body unit 200.

Here, a configuration example of the body unit information table in the present modification is shown in FIG. 12. The body unit information table in the present modification has a vibration resistance level field, in addition to the fields of the body ID, the size, and the weight as shown in FIG. 12. In the vibration resistance level field, information indicating the vibration resistance level of the body side equipment mounted on each of the body units 200 is registered. The information registered in the vibration resistance level field may be classified into, for example, five stages from level 1 to level 5. In that case, the level 1 is the smallest vibration resistance level, and the level 5 is the largest vibration resistance level.

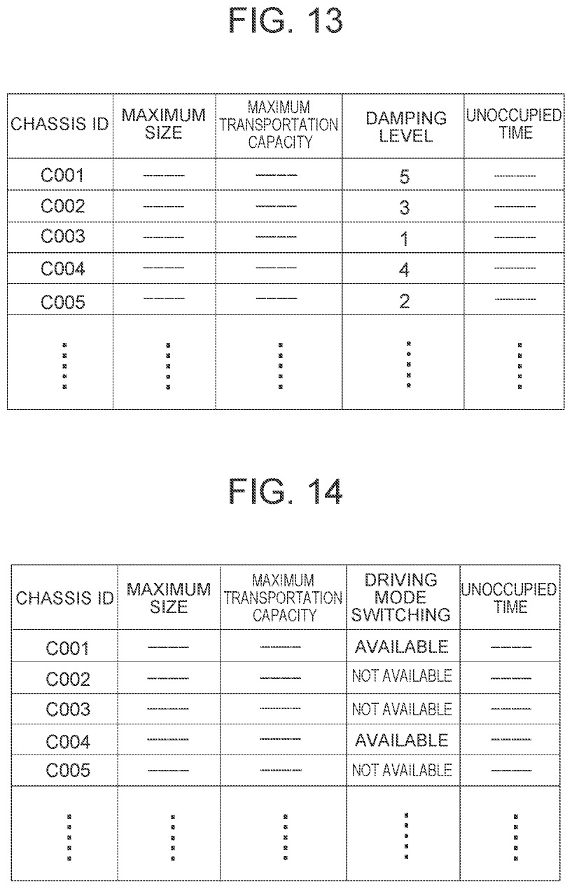

Next, a configuration example of the chassis unit information table in the present modification is shown in FIG. 13. The chassis unit information table in the present modification has a damping level field, in addition to the fields of the chassis ID, the maximum size, the maximum transportation capacity, and the unoccupied time as shown in FIG. 13. In the damping level field, information indicating the maximum damping level that can be achieved in each of the chassis unit 100 is registered. The information registered in the damping level field may be classified into five stages from level 1 to level 5. In that case, the level 1 is the smallest damping level, and the level 5 is the largest damping level.

In the case of selecting the mobile chassis unit 100 in the present modification, the selection processing unit F330 selects the mobile chassis unit 100 in consideration of the vibration resistance level of the body side equipment, in addition to the size and weight of the target body unit 200. For example, when the vibration resistance level of the body side equipment is level 1, the selection processing unit F330 selects, out of the chassis units 100 to be in the free state at the estimated movement date and time, the chassis unit 100 having the maximum size and the maximum transportation capacity adapted to the size and weight of the target body unit 200 and having the level 5 damping level, as the mobile chassis unit. When the vibration resistance level of the body side equipment is level 2, the selection processing unit F330 selects, out of the chassis units 100 to be in the free state at the estimated movement date and time, the chassis unit 100 having the maximum size and the maximum transportation capacity adapted to the size and weight of the target body unit 200 and having a level 4 or more damping level, as the mobile chassis unit. When the vibration resistance level of the body side equipment is level 3, the selection processing unit F330 selects, out of the chassis units 100 to be in the free state at the estimated movement date and time, the chassis unit 100 having the maximum size and the maximum transportation capacity adapted to the size and weight of the target body unit 200 and having a level 3 or more damping level, as the mobile chassis unit. When the vibration resistance level of the body side equipment is level 4, the selection processing unit F330 selects, out of the chassis units 100 to be in the free state at the estimated movement date and time, the chassis unit 100 having the maximum size and the maximum transportation capacity adapted to the size and weight of the target body unit 200 and having a level 2 or more damping level, as the mobile chassis unit. When the vibration resistance level of the body side equipment is level 5, the selection processing unit F330 selects, out of the chassis units 100 to be in the free state at the estimated movement date and time, the chassis unit 100 having the maximum size and the maximum transportation capacity adapted to the size and weight of the target body unit 200 and having a level 1 or more damping level, as the mobile chassis unit.

When the damping level of the mobile chassis unit 100 is variable, the command generation unit F340 may also transmit a setting command to the mobile chassis unit 100 when transmitting the movement command to the mobile chassis unit 100. The term “setting command” herein refers to a command for setting the damping level of the mobile chassis unit 100 to the level compatible with the vibration resistance level of the body side equipment.

According to the present modification, it is possible to select the chassis unit 100 having a damping level compatible with the vibration resistance level of the body side equipment, as the mobile chassis unit. This makes it possible to restrain failure in the body side equipment caused by traveling vibration or the like during movement of the target body unit 200.

### Third Modification of First Embodiment

It is also assumed that there are cases where the user of the target body unit 200 desires manual driving of the mobile chassis unit 100 when the target body unit 200 is moved by the mobile chassis unit 100. To cope with this situation, in the present modification, the mobile chassis unit 100 is selected in consideration of a driving mode that the user of the target body unit 200 desires.

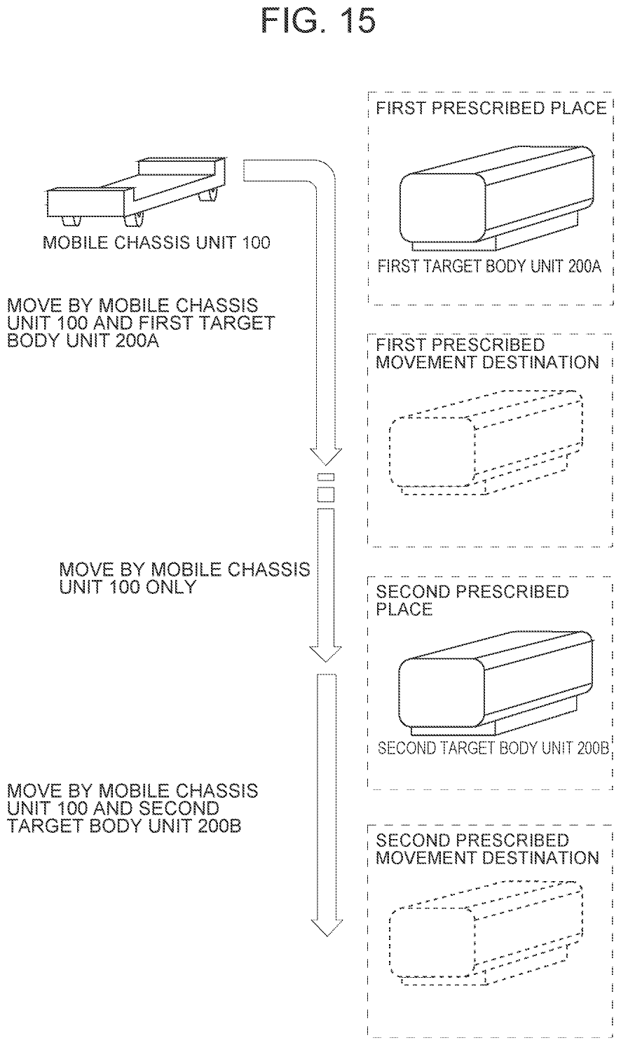

Here, the movement request in the present modification includes information indicating the driving mode desired by the user (information that specifies autonomous driving or manual driving), in addition to the body ID of the target body unit 200, the location information on the prescribed place, the location information on the prescribed movement destination, and the information indicating the estimated movement date and time. In this connection, the chassis unit information table in the present modification has a driving mode switching field, in addition to the fields of the chassis ID, the maximum size, the maximum transportation capacity, and the unoccupied time as shown in FIG. 14. In the driving mode switching field, information indicating whether or not switching between autonomous driving and manual driving is available is registered. For example, when the chassis unit 100 is formed such that switching between autonomous driving and manual driving is available, “available” is registered in the driving mode switching field. When the chassis unit 100 is formed such that switching between autonomous driving and manual driving is not available (when the chassis unit 100 is formed so as to be able to travel only by autonomous driving), “not available” is registered in the driving mode switching field.

In the case of selecting the mobile chassis unit 100 in the present modification, the selection processing unit F330 selects the mobile chassis unit 100 in consideration of the driving mode desired by the user, in addition to the size and weight of the target body unit 200. When the user desires manual driving in this case, the chassis unit 100 having the maximum size and the maximum transportation capacity adapted to the size and weight of the target body unit 200 and being formed such that switching between autonomous driving and manual driving is available is selected out of the chassis units 100 to be in the free state at the estimated movement date and time, as the mobile chassis unit. When the user desires autonomous driving, the mobile chassis unit may be selected in consideration of only the size and weight of the target body unit 200 as in the aforementioned embodiment.

According to the present modification, when the target body unit 200 is moved by the mobile chassis unit 100, the chassis unit 100 can be made to travel in the driving mode desired by the user.

### Second Embodiment

Now, a second embodiment of the present disclosure will be described. Here, description is given of an example where one mobile chassis unit is used to satisfy a plurality of movement requests. Note that the description of configuration and processes similar to those of the first embodiment is omitted.

Here, it may be assumed that there are cases where a plurality of movement requests may be satisfied more efficiently by one chassis unit in a sequential manner than by a plurality of chassis units in an individual manner. Accordingly, in the present embodiment, when the server device 300 accepts a first movement request and a second movement request, and a prescribed condition is established between these movement requests, one mobile chassis unit is used to satisfy both the movement requests. The term “first movement request” in this example refers to a request for moving a first target body unit 200A stationarily disposed in a first prescribed place from the first prescribed place to a first prescribed movement destination as shown in FIG. 15. The term “second movement request” refers to a request for moving a second target body unit 200B stationarily disposed in a second prescribed place from the second prescribed place to a second prescribed movement destination as shown in FIG. 15. The “prescribed condition” is to satisfy the following two conditions, for example.

First condition: a distance between the first prescribed movement destination and the second prescribed place is equal to or less than a prescribed distance.

Second condition: a difference between estimated date and time when the mobile chassis unit arrives at the first prescribed movement destination (estimated date and time of arrival) and estimated date and time of moving the second target body unit from the second prescribed place (estimated movement date and time) is equal to or less than specified time.

Note that the estimated arrival time is calculated based on, for example, a distance between the first prescribed movement destination and the second prescribed place, traffic congestion information regarding a route connecting these two places, or the like.

When the prescribed condition as described above is established, and the first target body unit 200A and the second target body unit 200B are continuously moved by one mobile chassis unit 100, it becomes possible to satisfy more movement requests. In the case where the number of the chassis units 100 in the free state is insufficient with respect to the number of the movement requests or the like in particular, it becomes possible to increase the number of the target body units which can be moved in accordance with the estimated movement date and time.

Process Flow

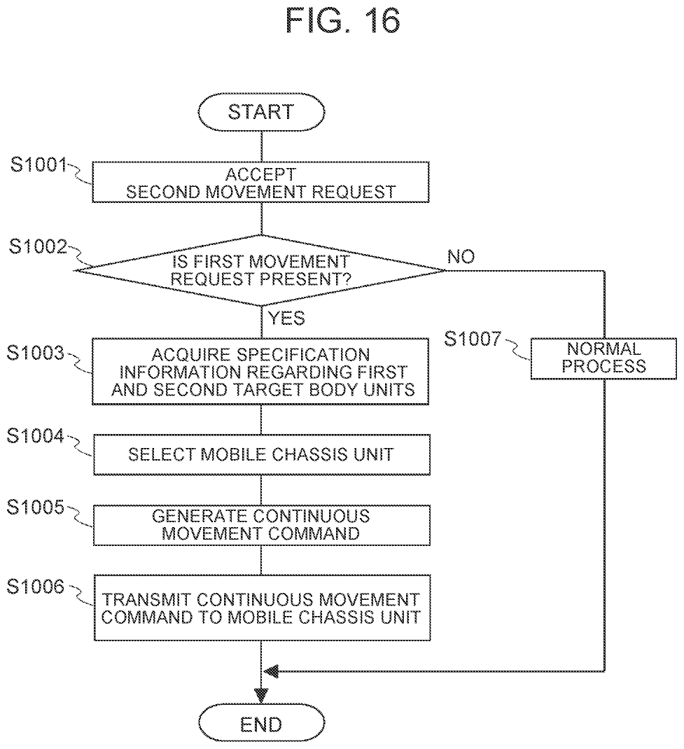

Hereinbelow, the flow of a process performed in the server device 300 in the present embodiment will be described based on FIG. 16. FIG. 16 is a flowchart showing the flow of the process executed by the server device 300 when the second movement request is received.

In FIG. 16, when the communication unit 304 of the server device 300 receives a second movement request, the request processing unit F310 accepts the second movement request (step S1001). The request processing unit F310 extracts the body ID of the target body unit 200, location information on the prescribed place, location information on the prescribed movement destination, and information indicating estimated movement date and time from the movement request. Then, the request processing unit F310 determines whether or not the movement requests already accepted include any movement request (first movement request) which satisfies the prescribed condition with respect to the second movement request (step S1002). Specifically, the request processing unit F310 determines whether or not the movement request (first movement request) that satisfies the following condition is already accepted. The condition is that the first prescribed movement destination is within a prescribed distance from the second prescribed place, and the estimated date and time of arrival at the first prescribed movement destination is within specified time from the estimated movement date and time of the second movement request.

Here, when the first movement request is not yet accepted (negative determination in step S1002), a normal process is executed (step S1007). The term “normal process” herein refers to the same process as in the first embodiment (process from step S102 to S105 in FIG. 9). When the first movement request is already accepted (positive determination in step S1002), then the specification acquisition unit F320 acquires specification information regarding the first target body unit 200A, and specification information regarding the second target body unit 200B (step S1003).

The selection processing unit F330 selects the mobile chassis unit 100 based on two pieces of the specification information acquired in step S1003 (step S1004). Specifically, the selection processing unit F330 first extracts the chassis unit information tables in which the unoccupied time, adapted to a time period including the estimated movement date and time of the first movement request and the estimated movement date and time of the second movement request, is registered in the unoccupied time field (fourth process). The selection processing unit F330 identifies, out of the chassis unit information tables extracted in the fourth process, the chassis unit information tables in which the maximum size that is equal to or more than the sizes of the first target body unit 200A and the second target body unit 200B is registered in the maximum size field (fifth process). The selection processing unit F330 identifies, out of the chassis unit information tables specified in the fifth process, the chassis unit information tables in which the maximum transportation capacity that is equal to or more than the weights of the first target body unit 200A and the second target body unit 200B is registered in the maximum transportation capacity field (sixth process). Then, the selection processing unit F330 determines the chassis unit 100 corresponding to the chassis unit information table identified in the sixth process as the mobile chassis unit. Thus, the chassis unit 100 which satisfies the condition required for moving both the first target body unit 200A and the second target body unit 200B is selected as the mobile chassis unit.

The command generation unit F340 generates a continuous movement command to the mobile chassis unit 100 selected in step S1004 (step S1005). The term “continuous movement command” herein refers to a command for continuously moving the first target body unit 200A and the second target body unit 200B in sequence. The command includes the following tenth to seventeenth commands.

Tenth command: a command for making the mobile chassis unit 100 travel such that the mobile chassis unit 100 arrives at the first prescribed place by the estimated movement date and time of the first target body unit 200A.

Eleventh command: a command for joining the mobile chassis unit 100 with the target body unit 200A at the first prescribed place.

Twelfth command: a command for making the mobile chassis unit 100 travel from the first prescribed place to the first prescribed movement destination.

Thirteenth command: a command for separating the mobile chassis unit 100 from the first target body unit 200A at the first prescribed movement destination.

Fourteenth command: a command for making the mobile chassis unit 100 travel such that the mobile chassis unit 100 arrives at the second prescribed place by the estimated movement date and time of the second target body unit 200B.

Fifteenth command: a command for joining the mobile chassis unit 100 with the second target body unit 200B at the second prescribed place.

Sixteenth command: a command for making the mobile chassis unit 100 travel from the second prescribed place to the second prescribed movement destination.

Seventeenth command: a command for separating the mobile chassis unit 100 from the second target body unit 200B at the second prescribed movement destination.

The continuous movement command generated in step S1005 is transmitted to the mobile chassis unit 100 through the communication unit 304 (step S1006).

In the mobile chassis unit 100 which has received the continuous movement command, the operation plan generation unit F110 generates an operation plan based on the continuous movement command. The operation plan in the present example includes a scheduled travel route starting from a departure point of the mobile chassis unit 100, passing the first prescribed place, the first prescribed movement destination, and the second prescribed place in sequence, and reaching the second prescribed movement destination. The operation plan in the present example further includes the process to be performed by the mobile chassis unit 100 in each of the first prescribed place, the first prescribed movement destination, the second prescribed place, and the second movement destination. The process to be performed by the mobile chassis unit 100 at the first prescribed place includes a process of joining the mobile chassis unit 100 to the first target body unit 200A. The process to be performed by the mobile chassis unit 100 at the first prescribed movement destination includes a process of separating the mobile chassis unit 100 from the first target body unit 200A. The process to be performed by the mobile chassis unit 100 at the second prescribed place includes a process of joining the mobile chassis unit 100 to the second target body unit 200B. The process to be performed by the mobile chassis unit 100 at the second prescribed movement destination includes a process of separating the mobile chassis unit 100 from the second target body unit 200B. When such an operation plan is generated, the travel control unit F130 of the mobile chassis unit 100 starts travel of the mobile chassis unit 100 at such a timing that the mobile chassis unit 100 arrives at the first prescribed place by the estimated movement date of the first target body unit 200A. When the mobile chassis unit 100 arrives at the first prescribed place, the joining control unit F140 controls the aforementioned external device or device mounted on the chassis unit 100, so as to join the mobile chassis unit 100 to the first target body unit 200A. When the joining work is completed, the travel control unit F130 resumes travel of the mobile chassis unit 100. When the mobile chassis unit 100 arrives at the first prescribed movement destination, the joining control unit F140 controls the aforementioned external device or device mounted on the chassis unit 100, so as to separate the mobile chassis unit 100 from the first target body unit 200A. When the separation work is completed, the travel control unit F130 resumes travel of the mobile chassis unit 100 at such a timing that the mobile chassis unit 100 arrives at the second prescribed place by the estimated movement date of the second target body unit 200B. When the mobile chassis unit 100 arrives at the second prescribed place, the joining control unit F140 controls the aforementioned external device or device mounted on the chassis unit 100, so as to join the mobile chassis unit 100 to the second target body unit 200B. When the joining work is completed, the travel control unit F130 resumes travel of the mobile chassis unit 100. When the mobile chassis unit 100 arrives at the second prescribed movement destination, the joining control unit F140 controls the aforementioned external device or device mounted on the chassis unit 100, so as to separate the mobile chassis unit 100 from the second target body unit 200B.

In the present embodiment, the first target body unit 200A and the second target body unit 200B can continuously be moved by one mobile chassis unit 100 in sequence. As a result, more movement requests can be satisfied in the case where the number of the chassis units in the free state is insufficient with respect to the number of the movement requests, or the like. Moreover, as compared with the case where a plurality of chassis units is operated, energy consumption can be reduced.

In the present embodiment, an example in which two movement requests are satisfied by one chassis unit 100 has been described. However, the same produces also applies in the case where three or more movement requests are satisfied by one chassis unit 100. Specifically, when the server device 300 which has received the first and second movement requests receive a third movement request, and the second movement request and the third movement request satisfy the conditions similar to the first condition and the second condition, then the three body units relating to the first to third movement requests can continuously be moved by one chassis unit 100 in sequence.

### Third Embodiment

Now, a third embodiment of the present disclosure will be described. Here, description is given of an example where the chassis units to be a target of the sharing service are possessions of individual owners. Note that the description of the component members and processes similar to those in the first embodiment is omitted.

Although there are cases where the chassis units owned by a provider of the service are used as the chassis units which are targets of the sharing service, it is also assumed that there are cases where the chassis units owned by individual users are used. When the chassis units which are the targets of the sharing service are possessions of the individual users, and the chassis units are used without permission of the users, the convenience of the individual users may be damaged. Accordingly, in the present embodiment, when a chassis unit is selected as the mobile chassis unit, a request for permission of use of the selected chassis unit is sent to the user of the chassis unit. Only when the permission of use is received from the user, the selected chassis unit is used for the movement work of the target body unit.

Process Flow

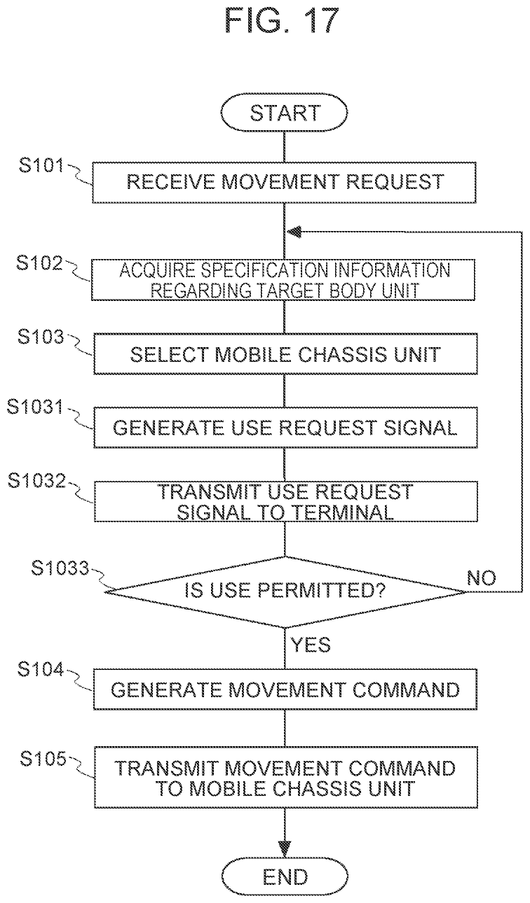

Hereinbelow, the flow of a process performed in the server device 300 in the present embodiment will be described based on FIG. 17. FIG. 17 is a flowchart showing the flow of the process executed by the server device 300 when a movement request is received. In FIG. 17, the processes equivalent to those in the flowchart in FIG.

9 are designated by the same reference numerals as in FIG. 9.

In FIG. 17, when the selection processing unit F330 selects the mobile chassis unit 100 (step S103), the process of step 51031 to step S1033 is executed before step S104 is executed.

In step S1031, the selection processing unit F330 generates a use request signal. The use request signal in this case includes information regarding a request for permission of use of the mobile chassis unit 100, and information regarding an incentive applied to the user when the mobile chassis unit 100 is used. The “incentive” herein includes, for example, an expense (electricity expense, road toll, or the like) required when the mobile chassis unit 100 is used for moving the target body unit 200, and a reward. The electricity expense in that case may be calculated based on the distance of the scheduled travel route, or the like. The reward may be a fixed value determined in advance, or may be a variable value changed in accordance with the duration of use of the mobile chassis unit 100. Presenting such an incentive to the user of the mobile chassis unit 100 can motivate the user to permit use of the mobile chassis unit 100. When the motor of the mobile chassis unit 100 includes an internal combustion engine, a fuel expense (expense for supplying the fuel consumed in the movement work) may be included in the incentive instead of the electricity expense. The use request signal generated by the selection processing unit F330 is transmitted to the terminal used by the user of the mobile chassis unit 100 that is selected in step S103 through the communication unit 304 (step S1032).

When a response signal to the use request signal is transmitted from the terminal to the server device 300, the selection processing unit F330 determines whether the response signal is a signal indicating permission of use of the mobile chassis unit 100 (step S1033). When the response signal is a signal indicating non-permission of use of the mobile chassis unit 100 (negative determination in step S1033), the selection processing unit F330 returns to the process of step S102, where a new mobile chassis unit 100 is selected again. Specifically, the selection processing unit F330 selects, out of the chassis units 100 except the chassis unit 100 which is determined to be unusable, a new mobile chassis unit 100. Then, the selection processing unit F330 may transmit the use request signal to the terminal used by the user of the new mobile chassis unit. When the response signal is a signal indicating permission of use of the mobile chassis unit 100 (positive determination in step S1033), the selection processing unit F330 delivers the chassis ID of the mobile chassis unit selected in step S103 to the command generation unit F340. In that case, the command generation unit F340 executes the process of step S104 and step S105 in sequence, so as to move the target body unit 200 by the mobile chassis unit 100.

When the chassis units which are the targets of the sharing service are possessions of users, the process flow shown in FIG. 17 makes it possible to conduct the moving work of the target body unit 200 without damaging the convenience of the users of the mobile chassis units.

Others

The embodiments and modifications disclosed are merely examples, and the present disclosure may appropriately be changed without departing from the concept thereof. For example, the embodiments and modifications disclosed can be combined as much as possible.

The processes or means described in the present disclosure can freely be combined and implemented without departing from the range of technical consistency. The processes described to be performed by one device may be executed by a plurality of devices in cooperation with each other. The processes described to be executed by a plurality of devices may be executed by one device. In a computer system, hardware configuration that implements each function may flexibly be changed.

The present disclosure can also be implemented when a computer program (information processing program), mounted with the functions described in the embodiments, is supplied to a computer, and one or more processors included in the computer read and execute the program. Such a computer program may be provided to the computer by a non-transitory computer readable storage medium that is connectable with a system bus of the computer, or may be provided to the computer through a network. The non-transitory computer readable storage medium is a recording medium which can store information, such as data and programs, by an electric, magnetic, optical, mechanical, or chemical action and which can read the information from a computer or the like. The storage medium is a disk or disc of any types, including magnetic disks (such as floppy (registered trademark) disks, and hard disk drives (HDDs)) and optical discs (such as CD-ROMs, DVD discs, and Blu-ray discs). The storage medium may also be a medium, such as a read-only memory (ROM), a random-access memory (RAM), an EPROM, an EEPROM, a magnetic card, a flash memory, an optical card, or a solid state drive (SSD).

What is claimed is:

1. An information processing device for managing operation of chassis units, the chassis units being formed to be freely joined to and separated from body units and be autonomously travelable by autonomous driving, the information processing device comprising a control unit configured to execute
accepting a movement request that is a request for moving a target body unit that is the body unit stationarily disposed in a prescribed place from the prescribed place to a prescribed movement destination,
acquiring specification information that is information regarding specification of the target body unit,
selecting, out of the chassis units in a state of being separated from the body units, the chassis unit adapted to the specification information as a mobile chassis unit that is the chassis unit for moving the target body unit, and
transmitting to the mobile chassis unit a movement command that is a command for moving the target body unit from the prescribed place to the prescribed movement destination.

2. The information processing device according to claim 1, wherein:
the specification information includes information regarding a size of the target body unit; and
the control unit is configured to select, out of the chassis units in the state of being separated from the body units, the chassis unit sized to be joinable with the target body unit as the mobile chassis unit.

3. The information processing device according to claim 1, wherein:
the specification information includes information regarding a weight of the target body unit; and
the control unit is configured to select, out of the chassis units in the state of being separated from the body units, the chassis unit having a maximum transportation capacity equal to or more than the weight of the target body unit as the mobile chassis unit.

4. The information processing device according to claim 1, wherein:
the specification information includes information regarding body side equipment that is equipment mounted on the target body unit; and
the control unit is configured to select, out of the chassis units in the state of being separated from the body units, the chassis unit mounted with chassis unit equipment that is required for operation of the body side equipment as the mobile chassis unit.

5. The information processing device according to claim 4, wherein when the chassis unit mounted with the chassis side equipment is not present in the chassis units in the state of being separated from the body units, the control unit is configured to execute
selecting, out of the chassis units in the state of being separated from the body units, any chassis unit as the mobile chassis unit,
transmitting to a prescribed composition base a mounting command that is a command for mounting the chassis side equipment on the mobile chassis unit, and
transmitting to the mobile chassis unit a movement command that is a command for moving the target body unit from the prescribed place to the prescribed movement destination after the mobile chassis unit passes through the prescribed composition base.

6. The information processing device according to claim 4, wherein:
the body side equipment is electric equipment; and
the chassis side equipment is power supply equipment that supplies electric power to the electric equipment.

7. The information processing device according to claim 4, wherein:
the body side equipment is water section equipment; and
the chassis side equipment is water supply equipment that supplies water to the water section equipment.

8. The information processing device according to claim 4, wherein:
the specification information includes information regarding vibration resistance of the body side equipment that is equipment mounted on the target body unit; and
the control unit is configured to select, out of the chassis units in the state of being separated from the body units, the chassis unit having a damping characteristic compatible with the vibration resistance of the body side equipment as the mobile chassis unit.

9. The information processing device according to claim 8, wherein when the damping characteristic of the mobile chassis unit is variable, the control unit is configured to transmit to the mobile chassis unit, at a time of transmitting the movement command to the mobile chassis unit, a setting command that is a command for setting the damping characteristic of the mobile chassis unit to be compatible with the vibration resistance of the body side equipment.

10. The information processing device according to claim 1, wherein when a user of the target body unit desires manual driving of the chassis unit, the control unit is configured to select, out of the chassis units in the state of being separated from the body units, the chassis unit adapted to the specification information and switchable between autonomous driving and the manual driving, as the mobile chassis unit.

11. The information processing device according to claim 1, wherein when a first movement request for moving a first target body unit stationarily disposed in a first prescribed place from the first prescribed place to a first prescribed movement destination and a second movement request for moving a second target body unit stationarily disposed in a second prescribed place from the second prescribed place to a second prescribed movement destination are accepted, and a prescribed condition is established between the first movement request and the second movement request, the control unit is configured to execute
selecting, out of the chassis units in the state of being separated from the body units, the chassis unit adapted to the specification information regarding both the first target body unit and the second target body unit as the mobile chassis unit, and
transmitting to the mobile chassis unit a continuous movement command that is a movement command for moving the first target body unit and the second target body unit in sequence.

12. The information processing device according to claim 11, wherein the prescribed condition is that a distance between the first prescribed movement destination and the second prescribed place is equal to or less than a prescribed distance, and that a difference between estimated date and time of the mobile chassis unit arriving at the first prescribed movement destination and estimated date and time of moving the second target body unit from the second prescribed place is equal to or less than specified time.

13. The information processing device according to claim 1, wherein:
when the mobile chassis unit is selected, the control unit is configured to further execute transmitting a use request that is a request for permission of use of the mobile chassis unit to a terminal used by the user of the mobile chassis unit; and
when a signal indicating the permission of use of the mobile chassis unit is received from the terminal, the control unit is configured to transmit the movement command to the mobile chassis unit.

14. The information processing device according to claim 13, wherein the use request includes information regarding an incentive that is applied when the use of the mobile chassis unit is permitted.

15. The information processing device according to claim 13, wherein when receiving a signal indicating non-permission of use of the mobile chassis unit from the terminal, the control unit is configured to select, out of the chassis units in the state of being separated from the body units, the chassis unit other than the chassis unit selected as the mobile chassis unit, as a new mobile chassis unit.

16. The information processing device according to claim 1, wherein the movement request includes information indicating a location of the prescribed place, information indicating a location of the prescribed movement destination, and information indicating estimated movement date and time that are date and time to move the target body unit from the prescribed place.

17. The information processing device according to claim 16, wherein the movement command includes
a command for making the mobile chassis unit travel such that the mobile chassis unit arrives at the prescribed place by the estimated movement date and time,
a command for joining the mobile chassis unit with the target body unit in the prescribed place,
a command for making the chassis unit travel from the prescribed place to the prescribed movement destination, and
a command for separating the mobile chassis unit from the target body unit in the prescribed movement destination.

18. The information processing device according to claim 1, wherein the target body unit has staying space reserved for the user to use while the user stays in the prescribed place.

19. An information processing method for managing chassis units formed to be freely joined to and separated from body units and be autonomously travelable by autonomous driving, the information processing method being executed by a computer, the method comprising:
a step of accepting a movement request that is a request for moving a target body unit that is the body unit stationarily disposed in a prescribed place from the prescribed place to a prescribed movement destination;
a step of acquiring specification information that is information regarding specification of the target body unit;
a step of selecting, out of the chassis units in a state of being separated from the body units, the chassis unit adapted to the specification information, as a mobile chassis unit that is the chassis unit for moving the target body unit; and
a step of transmitting to the mobile chassis unit a movement command that is a command for moving the target body unit from the prescribed place to the prescribed movement destination.

20. An information processing system, comprising:
chassis units formed to be freely joined to and separated from body units and be autonomously travelable by autonomous driving; and
an information processing device for managing operation of the chassis units, wherein:
the information processing device is configured to execute
accepting a movement request that is a request for moving a target body unit that is the body unit stationarily disposed in a prescribed place from the prescribed place to a prescribed movement destination,
acquiring specification information that is information regarding specification of the target body unit,
selecting, out of the chassis units in a state of being separated from the body units, the chassis unit adapted to the specification information as a mobile chassis unit that is the chassis unit for moving the target body unit, and
transmitting to the mobile chassis unit a movement command that is a command for moving the target body unit from the prescribed place to the prescribed movement destination; and
the mobile chassis unit is configured to execute
receiving the movement command from the information processing device,
generating an operation plan of the mobile chassis unit based on the movement command, and
operating the mobile chassis unit in accordance with the operation plan.
